(19) United States
(12) Patent Application Publication
(10) Pub. No.: US 2003/0182895 A1
(43) Pub. Date: Oct. 2, 2003

(54) Foamed adhesive and use thereof

(76) Inventors: Ronald J. Skrzyniarz, Easton, PA (US); David W. Lydzinski, Belle Mead, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/114,649

(22) Filed: Apr. 2, 2002

(51) Int. Cl. E06B 3/70

(52) U.S. Cl. 52/784.1; 156/332; 156/78

(57) ABSTRACT

Hardwood surface materials can be bonded to a substrate material such as particleboard using a foamed adhesive. Method finds particular usefulness in the manufacture of interior doors.

### FIELD OF THE INVENTION

The invention relates to an article of manufacture, in particular flush doors, prepared using a foamed adhesive.

### BACKGROUND OF THE INVENTION

Laminated products have largely replaced natural materials in the construction of furniture, cabinets, countertops, interior doors and the like, due in large part to the strength, durability, decorativeness and cost of these products. Such products are typically prepared by bonding a surface material to a core material using an adhesive, and application of heat and/or pressure. Interior doors, for example, are conventionally manufactured by bonding a hardboard door facing or other conventional surface material to a particleboard or other conventional frame or core material.

While liquid solvent-based adhesives and aqueous liquid adhesives have been used to bond substrate materials, these adhesives have a number of disadvantages associated with their use. Solvent-based adhesives pose environmental and health hazards and are difficult to handle. Aqueous liquid adhesives require significant drying times, require long set or cure times, and the water contained within them tends to swell surface and/or core materials leading to warpage.

A need thus exists for alternative methods of preparing laminated doors for interior passage door usage. The current invention provides a method of preparing laminated articles, including doors, which is safe, effective and, in addition, provides substantial cost savings.

### SUMMARY OF THE INVENTION

The present invention relates to an adhesive and, more particularly, to manufactured doors comprising the adhesive. In a preferred embodiment, the adhesive is used in the foamed state.

One aspect of the invention is directed to a foamed adhesive comprising at least one resin emulsion. In a preferred embodiment, the at least one resin emulsion comprises a polyvinyl acetate. Even more preferably, the at least one resin emulsion is a polyvinyl acetate emulsion. The adhesive may also comprises a filler, a surface active agent and/or other additive.

Another aspect of the invention is directed to an article of manufacture comprising the foamed adhesive described herein. The article comprises a core material and a surface material, wherein the core material and surface material are bonded together with the foamed adhesive, preferably a foamed polyvinyl acetate emulsion-based adhesive. In a preferred embodiment, the substrate material is a wood composite material and the surface material is a hardboard material. Particularly preferred articles of manufacture encompassed by the invention are flush doors.

Yet another aspect of the invention is directed to a method for bonding materials together which comprises applying the foamed adhesive composition of the invention to a first substrate, bringing a second substrate in contact with the adhesive composition applied to the first substrate, and subjecting the applied composition to conditions which will allow the composition to form a set bond. In a preferred embodiment, at least one of said substrates comprises a wood composite material. In a particularly preferred embodiment, one substrate is a wood composite and one substrate is a hardboard.

Still another aspect of the invention is directed to a method of manufacturing a door comprising applying a foamed adhesive to a first substrate, bringing a second substrate in contact with the adhesive composition applied to the first substrate, and subjecting the applied composition to conditions which will allow the composition to form a set bond, wherein one of said first or second substrate is a core material and the other of said first or second substrate is a surfacing substrate, and wherein the adhesive comprises at least one resin emulsion.

### DETAILED DESCRIPTION OF THE INVENTION

It has now been discovered that emulsion-based adhesives in the foamed state, in particular polyvinyl acetate emulsion-based adhesives, may be used for bonding door skins to frame or core materials such as particleboard. By foaming, less water is introduced into the construction, drying time is decreased and the amount of adhesive used by the manufacturer is substantially reduced resulting in a economic advantage to the user of the adhesive in the manufacture of goods therewith.

The adhesives of the invention may be used to prepare various articles of manufacture, but are particularly useful in bonding hard wood veneers to particleboard cores in the manufacture of doors. The adhesive of the invention is particularly advantageous when used in the manufacture of flush doors. Flush doors are also alternatively referred to herein as flat-skinned doors or as interior or passage doors. Both solid and “hollow” core doors can be manufactured using the foamed adhesive of the invention.

The doors of the invention comprise a core sandwiched between two external flush panels adhesively secured to the core. The core may be solid material or, as in the case of “hollow” core doors, comprise perimeter vertical and horizontal frame members. Included within the definition of a solid core door are “honeycomb” core doors.

Hollow core doors are known in the art. A typical hollow core door includes a perimeter frame with vertically extending stiles and top and bottom rails, with a pair of opposing door skins secured to the frame member. Hollow core doors according to the invention comprise a door frame including first and second stiles that are oriented substantially parallel to one another, a top rail member and a bottom rail member; first and second door skins, each of said door skins being substantially planar in shape; said first door skin affixed to a first side of said door frame and said second door skin affixed to a second side of said door frame. It will be appreciated that the first and second door skin material can be identical or different. Hollow core doors manufactured in accordance with the invention are particularly advantageous from the standpoint of ease of handling and cost of transportation since such doors typically weigh less than solid core doors.

In addition to hardwood, surfacing or door skin materials include decorative laminates such as particle board, a resin-binded wood fiberboard, multiple sheets of phenolic resin-impregnated sheets of e.g., Kraft paper, etc. and the like. The thickness of the surfacing material used in the practice of the invention is not critical, but will generally range in thickness from about 3/16 inch to about ⅜ inch.

The terms “wood composite” and “particle board” are used interchangeably through out this disclosure. These terms are meant to encompass chip board, particleboard, medium density fiberboard, high density fiberboard, oriented strandboard, hardboard, hardwood plywood, veneer core plywood, isocyanate or phenolic impregnated strawboard, and wood composites made from woodfiber and polymers, such as recycled polyethylene. The core material may be made of, e.g., expanded polystyrene foam, a honeycomb or reticulated structure, and the like. Typically, the honeycomb or reticulated structure, when used as the core material, is defined by a plurality of parallel strips of sheet material, each strip being formed into a sinous path and bonded to immediately adjacent strips at its outwardly bowed extremities, and is formed of paper, typically Kraft paper. The paper can be untreated or impregnated with a suitable resin for increased stiffness.

The doors may advantageously be prepared by applying adhesive in its foamed form to a core, applying the door surfacing members, i.e., front and back panels, and allowing the adhesive to form a set dry bond. Preferred foamed adhesives comprise at least one resin emulsion, and may also comprise at least one filler as well as other additives. Typically, the foamed adhesive comprises more than about 30%, more typically from about 50% by weight to about 100%, more preferably 55% by weight to about 85% by weight of the resin emulsion, and from 0% by weight to about 50% by weight, more typically from about 5% to about 20% % by weight of filler and/or other conventional additives. Foamed adhesives comprising a blend of two or more polyvinyl acetate emulsions are contemplated.

Resin emulsions that may be used in the practice of the invention are emulsions and mixtures having a high glass transition temperature (i.e., a Tg greater than about 10° C.). Polyvinyl acetate is a preferred for use in the practice of the invention. Mixtures of two or more polyvinyl acetates and mixtures of polyvinyl acetate and other polymer emulsions and monomers, including but not limited to ethylene vinyl acetate and acrylic monomers, are encompassed. Polyvinyl acetate may be prepared using a continuous or a batch process. Polyvinyl acetate emulsion mixtures wherein the polyvinyl acetates used are prepared by one method or by both methods may be used. Such polyvinyl acetates are commercially available from National Starch and Chemical, Bridgewater, N.J.

The adhesive may also contain a filler. The addition of a filler allows for foam generated to remain consistent and stable for several hours. Suitable fillers are those fillers known in the art as adhesives fillers and include polysaccharides, calcium carbonate, clay, mica, nut shell flours, silica, talc and wood flour.

Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

In addition to fillers, other additives typical of adhesive compositions may be added to the foamable composition. Said additives include, but are not limited to, plasticizers, acids, waxes, synthetic resins, tackifiers, defoamers, preservatives, bases such as sodium hydroxide, dyes, pigments, UV indicators, and other additives commonly used in the art.

The adhesive may also contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. When used, the surface active agent will typically be added in amounts up to about 20% by weight, based on the foamable composition as a whole. More usually from amounts of from about 0.05 to about 20% by weight, and preferably at from 0.2 to 2% by weight.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 10% (by volume) up to about 50% (by volume) or greater.

The adhesive may be applied by any method known in the art. Typically the core material and/or the surfacing material is coated with up to about 10 wet mils of foamed adhesive. Preferably, the foamed adhesive is applied using a roll coater, also referred to in the art as a glue spreader. The surfacing material substrate is brought in contact with the core material substrate to form the manufactured door. The doors are stacked and cold pressed.

The invention is further illustrated by the following non-limiting examples.

### EXAMPLES

### Example 1

An adhesive composition was prepared using 29.8% of a polyvinyl acetate prepared using batch polymerization process, 54.7% of a polyvinyl acetate prepared using a continuous polymerization process, 9.9% corn starch, 5.4% of a plastizer and 0.1% of a preservative.

### Example 2

The adhesive having the formulation of Example 1, both prior to foaming and following foaming to 30% using a Hansa foaming unit, was used to bond hardwood facing material to a medium density fiberboard (pine) core frame. Bonds were made with the foamed and the unfoamed adhesive by coating the hardboard with a #40 wirewound bar. The bonded samples were then stacked under pressure for 20 minutes before pressing for 60 minutes at 20 pounds per square inch. The bonds were allowed to cure for one week before testing. Comparable adhesion was seen with both the foamed and the unfoamed adhesive.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A manufactured door comprising a core material bonded to a surface material with a foamed adhesive, the foamed adhesive comprising at least one resin emulsion.

2. The door of claim 1 wherein a first surface material is bonded to at least one side of the core material and a second surface material is bonded to at least a second side of the core material.

3. The door of claim 1 wherein the adhesive is foamed from about 20 to about 60% weight by volume.

4. The door of claim 1 wherein the adhesive comprises at least one polyvinyl acetate emulsion.

5. The door of claim 4 wherein the adhesive comprises a blend of at least two polyvinyl acetates.

6. The door of claim 5 wherein at least one polyvinyl acetate is prepared by batch polymerization and at least one polyvinyl acetate is prepared by continuous polymerization.

7. The door of claim 1 wherein the adhesive comprises from about 55 to about 85% of said at least one resin emulsion.

8. The door of claim 1 wherein the core material comprises a particle board.

9. The door of claim 1 wherein the surface material comprises a hardwood.

10. The door of claim 1 which is a flush door.

11. The door of claim 10 which is a solid core door.

12. The door of claim 10 which is a hollow core door.

13. A method of manufacturing a door comprising applying a foamed adhesive to a first substrate, bringing a second substrate in contact with the adhesive composition applied to the first substrate, and subjecting the applied composition to conditions which will allow the composition to form a set bond, wherein one of said first or second substrate is a core material and the other of said first or second substrate is a surfacing substrate, and wherein the adhesive comprises at least one resin emulsion.

14. The method of claim 13 wherein said core comprises perimeter vertical and horizontal frame members.

15. The method of claim 13 wherein the adhesive comprises at least one polyvinyl acetate emulsion.
